(19) United States
(12) Patent Application Publication
(10) Pub. No.: US 2005/0010896 A1
(43) Pub. Date: Jan. 13, 2005

(54) Universal format transformation between relational database management systems and extensible markup language using XML relational transformation

(75) Inventors: Dikran Meliksetian, Danbury, CT (US); Jessica Wu Ramirez, Danbury, CT (US); Nianjun Zhou, Somers, NY (US)

Correspondence Address: John E. Campbell;IBM Corporation, 2455 South Road, P386, Poughkeepsie, NY, 12601, US

(73) Assignee: International Business Machines Corporation, Armonk, NY (US)

(21) Appl. No.: 10/614,664

(22) Filed: Jul. 7, 2003

(51) Int. Cl. G06F 9/44

(52) U.S. Cl. 717/106; 717/136; 717/114

(57) ABSTRACT

A program product, system and method for transforming data between an XML representation and a relational database system wherein a mapping description is created in a mark-up language such as XML and XSL. The mapping description specifying a set of conditions for source data to satisfy. When mapping to XML, an XML output format is specified in the mapping description and the data is formatted accordingly. When mapping to a RDBMS, actions to be executed on the RDBMS tables are specified in the mapping description and the actions are perfomed.

### FIELD OF THE INVENTION

The present invention is related to Relational Database Management Systems (RDBMS) and XML electronic documents and more particularly to systems for mapping transformation between RDBMS and XML.

### BACKGROUND OF THE INVENTION

While XML is becoming the predominant language for exchanging information over the Internet and the basis for enabling server-to-server communications in a heterogeneous computing environment, relational databases still remain the primary choice for enterprise information storage. An outstanding issue raised by this evolution is to determine methods for efficient storage and retrieval of information represented in XML. Consequently, methods for efficiently mapping between XML documents and relational databases is necessary.

For example, in the current state of the art, an inventory control system is usually implemented as a relational database (RDB). However a B2C (Business to Customer) application that interfaces with this system and allows external customers to order parts will often use extensible Markup Language (XML) as the syntax for document exchanges. The application has to transform between the two representations (RDB and XML). In another example, the same inventory control system will be used to create human readable reports in either XML or XHTML format. Again there is a need for an application to do a transformation from one representation domain to another (XML and XHTML). In the prior art this transformation is performed by incorporating specialized code in the applications, with the consequence that any change in either the XML interchange format or the database schema would require a change in the application code itself.

The same need has been recognized by others. For example IBM offers the “DB2 XML Extender” package. It is an add-on to the IBM DB2 DBMS. DB2 XML Extender uses an XML file called a Document Access Definition (DAD). The DAD describes the mapping between the XML and the database objects. It is tightly integrated with DB2 and usable only with DB2 databases. Other database vendors have also proposed proprietary solutions to this problem which are, as in the case of the “DB2 XML Extender” package, applicable only for that specific database. Also, those solutions are heavily slanted towards the database schema that they support and the XML that can be created is constrained by that schema. What is needed is a middleware solution that is independent of the underlying database, and treats both the database schema and the XML document structure in a balanced way. Such a solution, in a multi-tier environment, should be able to run on a tier different from the tier that the database is running on.

### SUMMARY OF THE INVENTION

Some of the terminology used in the present specification is defined as follows:
JDBC—Java Database Connectivity. A standard method of connecting to and communicating with databases using Java.
RDBMS—Relational Database Management System.
SAX—Simple API for XML is an event-based method of parsing an XML document. The events are passed to the application in the form of callbacks, thus an internal tree is never built into the system's memory.
SQL—Structured Query Language is a standard language used to describe queries to obtain or insert objects from a database.
XML—extensible Markup Language is a W3C standard language used to provide structure for documents and data on the Web.
XRT—XML Relational Transformation is the proposed method to use SQL and JDBC to obtain objects from a database and return them in a structured XML format.
XSL—extensible Stylesheet Language is a W3C standard language to transform XML documents using a template-based approach. XSL is used in conjunction with XPath to transform XML documents into any number of different types of output formats.

The present invention externalizes the transformation specification into a script and provides the design of an engine that would act on that specification. It can be used as a building block for applications that need to transform from one domain to the other. The advantages of this externalization are the separation of the transformation specific code from the application logic, and the ease with which any changes in either the database schema or the XML structure can be handled without application code changes.

The present invention proposes a notation called “XML Relational Transformation Scripting Language” (XRTL). Example XRTL notation is demonstrated in tables 2 and 3. The notation uses XSL and enhances it with additional constructs to describe transformations between XML and relational data. The transformation is defined at the structure level rather than the instance level, which is specified by an XRT script file.

As previously mentioned, there are some approaches to address the problem of providing an XML interface to RDBMS systems. In the aforementioned DB2 XML Extender, the ability to access data and to return the data as XML is provided, but a separate transformation (DAD) is required to create a particular format. DB2 XML Extender is a proprietary solution for the DB2 DBMS. The present invention provides XRT which can be reused for any RDBMS, as long as that DB supports JDBC. JDBC (Java Database Connectivity) is a standard method of connecting to and communicating with databases.

For example, DB2 XML Extender of the prior art creates, in an intermediate step, a DOM object to represent the XML. The memory requirements for maintaining the DOM object place limitations on the size of XML documents that can be handled by DB2 XML Extender. The present invention uses a single parsing of the input XML document to do data access and transformation, via SAX events, and thus does not have the same size limitations.

XQuery of the prior art is only a notation specification, not an evaluation algorithm. As an extension of the W3C standard XPath language, XQuery is used to select pieces of an XML document, to be used in creating new documents. Thus, XQuery only provides a method of querying XML elements but not an entire database-to-XML implementation as provided by the present invention. In one embodiment, the techniques of the present invention can be used to implement XQuery syntax for the transformation.

The proposed notation XRTL and the corresponding engines can be used in a variety of applications (such as Web Content Management Systems, Knowledge Management Systems, and Business to Business transactions for example), where there is the need to extract selected XML elements and to store them in a relational database, or to compose an XML object from various data sources including relational databases.

Some advantages of the present invention are:
1. Minimal programming or coding is required. Users write simple scripts to map information objects between XML and relational databases. Updates to the mappings are done externally in the scripts so core application components need not be modified;
2. Rich mapping functions. By applying the functions supported by XSL, users can easily achieve complex bi-directional mapping requirement between XML and a database;
3. Open Standards. The invention preferably employes open standard elements such as XML, XSL and JDBC;
4. Vendor-neutral. Any RDBMS that supports the JDBC interface can be used for storage;
5. Easy Integration with Web Services. Because the method is designed to be vendor and language neutral, it is easy to integrate it with the emerging XML support for Web Services

The above as well as additional objectives, features, and advantages of the present invention will become apparent in the following written description.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting components of a prior art computer system;

FIG. 2 is a diagram depicting components of a prior art computer network;

FIG. 3A, FIG. 3B and FIG. 3C are diagrams depicting different exemplary embodiments of the invention;

FIG. 4 is a diagram depicting an example Relational Database structure;

FIG. 5 is a diagram of a Search Tree used in an XRT Retrieval Procedure;

FIG. 6 is a diagram of a Transaction Tree used in a XRT Shredding Procedure;

FIG. 7 is a diagram of the components of an example XRT Retrieval procedure;

FIG. 8A and FIG. 8B depict a Flow Diagram of a XRT Retrieval procedure;

FIG. 9 is a diagram of the components of an example XRT Shredding procedure; and

FIG. 10A, FIG. 10B and FIG. 10C depict a Flow Diagram of the XRT Shredding procedure.

### DESCRIPTION OF THE PREFERRED EMBODIMENTS

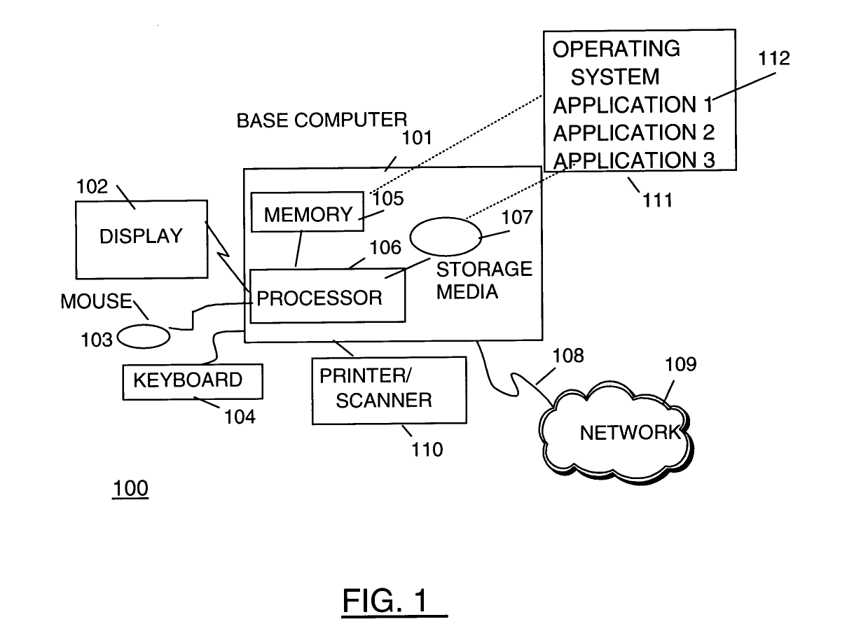

FIG. 1 illustrates a representative workstation or server hardware system in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating with a network 109. Example network adapters are communications channels, token ring, Ethernet or modems. Alternatively, the workstation 101 may communicate using a wireless interface, such as a CDPD (cellular digital packet data) card. The workstation 101 may be associated with such other computers in a local area network (LAN) or a wide area network (WAN), or the workstation 101 can be a client in a client/server arrangement with another computer, etc. All of these configurations, as well as the appropriate communications hardware and software, are known in the art.

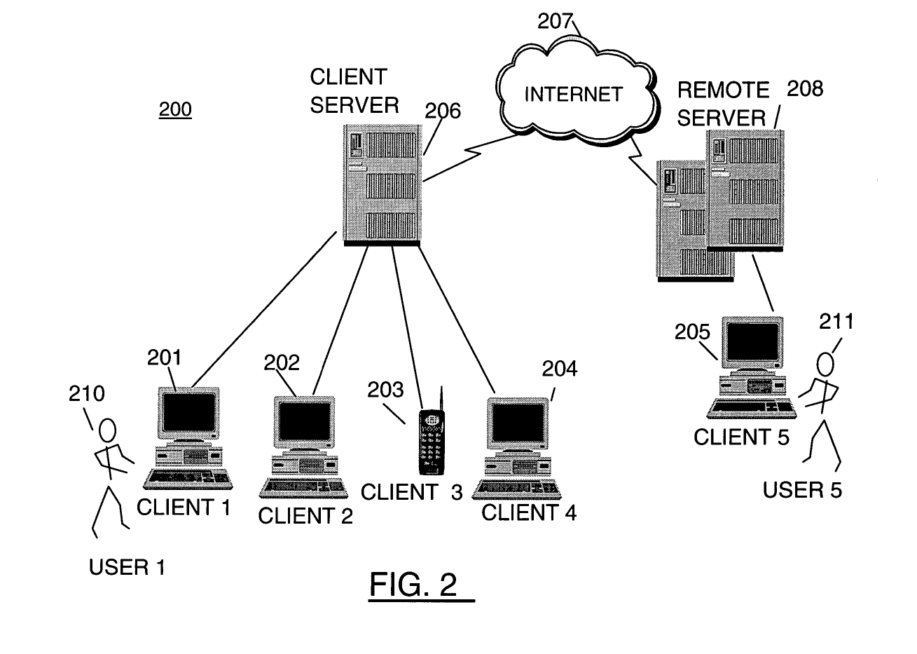

FIG. 2 illustrates a data processing network 200 in which the present invention may be practiced. The data processing network 200 may include a plurality of individual networks, such as wireless network and a wire network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer, zServer, 900 Server available from IBM.

Software programming code which embodies the present invention is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the processor 106 using the processor bus. Such programming code includes an operating system which controls the function and interaction of the various computer components and one or more application programs. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

In the preferred embodiment, the present invention is implemented as one or more computer software programs 111. The implementation of the software of the present invention may operate on a user's workstation, as one or more modules or applications 111 (also referred to as code subroutines, or “objects” in object-oriented programming) which are invoked upon request. Alternatively, the software may operate on a server in a network, or in any device capable of executing the program code implementing the present invention. The logic implementing this invention may be integrated within the code of an application program, or it may be implemented as one or more separate utility modules which are invoked by that application, without deviating from the inventive concepts disclosed herein. The application 111 may be executing in a Web environment, where a Web server provides services in response to requests from a client connected through the Internet. In another embodiment, the application may be executing in a corporate intranet or extranet, or in any other network environment. Configurations for the environment include a client/server network, Peer-to-Peer networks (wherein clients interact directly by performing both client and server function) as well as a multi-tier environment. These environments and configurations are well known in the art.

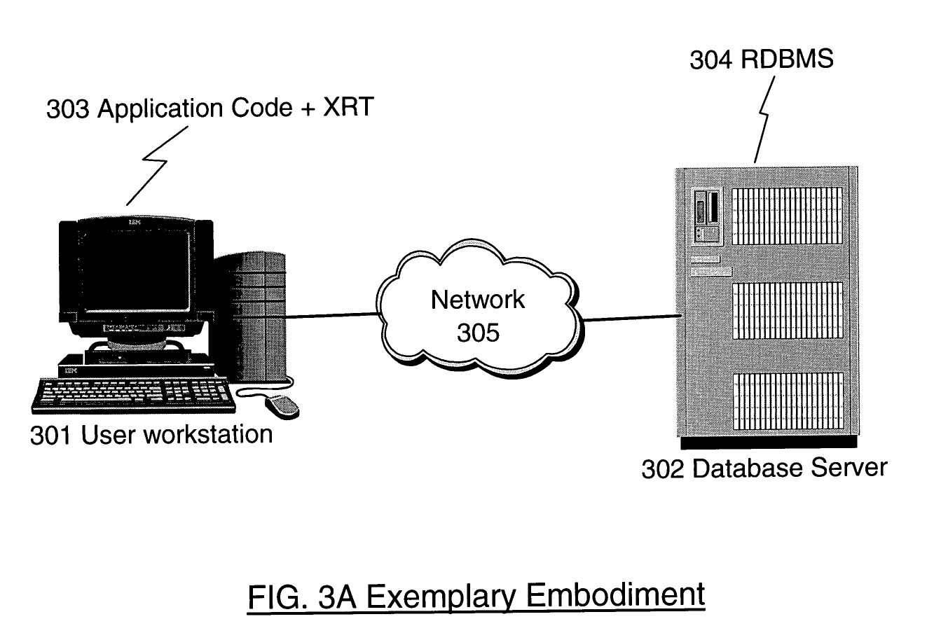

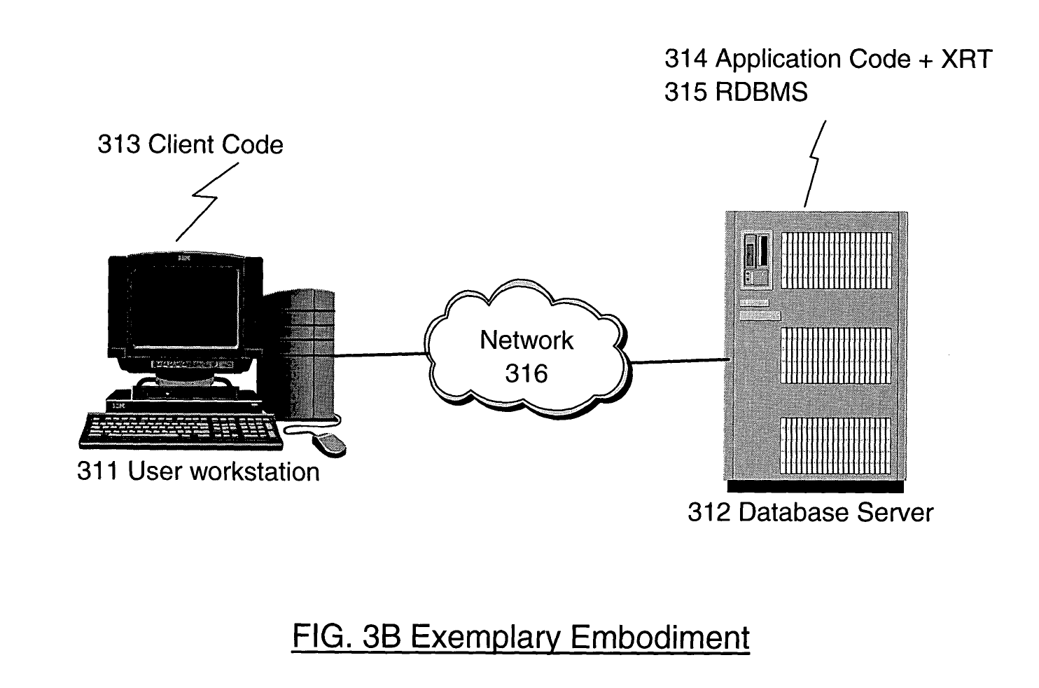

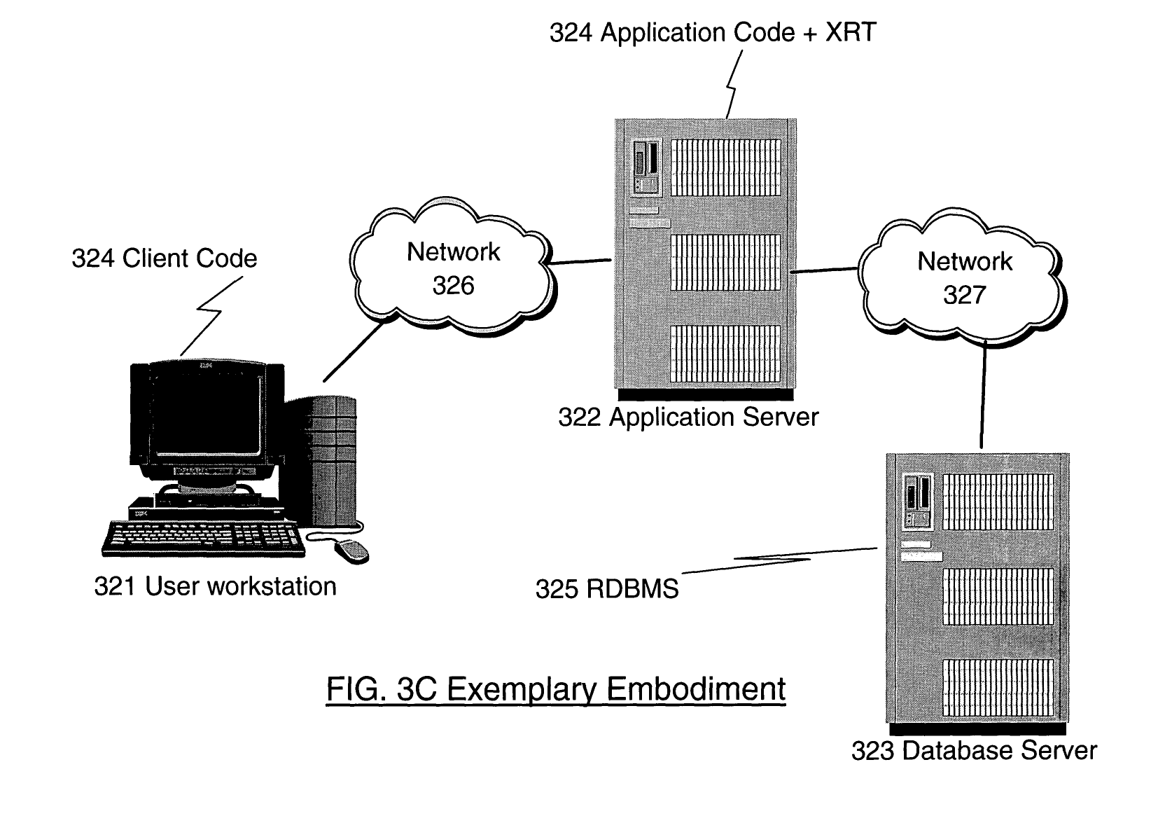

FIG. 3A depicts an exemplary embodiment of the invention where the application code in conjunction with the XRT modules 303 execute on the user's workstation 301 and access a remote database 304 running on the database server 302 via the network 305. A variant of this embodiment will have multiple database servers that the application code can access.

FIG. 3B depicts another embodiment, where the XRT module and the associated application code 314 are executed on the same server 312, which also runs the database code 315. The user accesses the results through the network 316 from workstation 311 using the client code 313. In this embodiment the client code might be an application specific program or a web browser that accesses the application though the http protocol. The client code may also be in the form of a web service client system that accesses the application using SOAP.

FIG. 3C depicts yet another embodiment where the application code and the XRT module 324 execute on an application server 322 separate from the database server 323 that hosts the database 325. The user accesses the results in the same fashion as the embodiment in FIG. 3B from a user workstation 321 using the client code 324 that might be an application specific code or a general purpose browser that interfaces to the application. The application code and XRT module 324 accesses data from the database 325 through JDBC communication on the network 327. In this case as in the case of FIG. 3A, the application code and XRT 324 might access more than one database server 323.

In a preferred embodiment, application data (that is requested by the user workstation) is in the form of XML documents. XML, or “extensible Markup Language”, is a standard format for structuring data using tags, or markups, to specify semantic information about the data. It should be noted that the term “record” is used herein to refer to data stored in a repository. This is for ease of reference, and is not meant to limit the present invention to use with conventional record-oriented repositories. Specifically, representations such as object-oriented formats are to be considered as being within the scope of the present invention.

TABLE 1
(XML):

| | |
|---|---|
| A1 | <?xml version=“1.0”?> |
| A2 | <polist> |
| A3 | <po> |
| A4 | <id>500</id> |
| A5 | <buyer id=“101”>Corporation A</buyer> |
| A6 | <seller id=“100”>My Corporation</seller> |
| A7 | <buyer_cn>Jane Doe</buyer_cn> |
| A8 | <lineitem amount=“100”> |
| A9 | <prodid>303030</prodid> |
| A10 | <name>Widget A</name> |
| A11 | <price>1200</price> |
| A12 | </lineitem> |
| A13 | </po> |
| A14 | <po> |
| A15 | <id>501</id> |
| A16 | <buyer id=“102”>Corporation B</buyer> |
| A17 | <seller id=“100”>My Corporation</seller> |
| A18 | <buyer_cn>John Doe</buyer_cn> |
| A19 | <lineitem amount=“50”> |
| A20 | <prodid>303031</prodid> |
| A21 | <name>Widget B</name> |
| A22 | <price>850</price> |
| A23 | </lineitem> |
| A24 | </po> |
| A25 | </polist> |

An example of a source data structure specified in XML syntax, upon which the present invention may operate, is shown in TABLE 1 (lines A1-A25). This example will be used to illustrate a preferred format for the source data structure used by the present invention. This example represents a purchase order list. There are two purchase orders specified in TABLE 1, with the first purchase order beginning at line A2 and ending at line A12, and the second purchase order beginning at line A13 and ending at line A23. Each purchase order contains an id number (lines A3 and A14), buyer information (lines A4, A6, A15, and A17), seller information (lines A5 and A16), and information on each item purchased (lines A7-A11, A18-A22).

Records representing any type of structured source information may be specified for use by the present invention in a similar manner to the record depicted in TABLE 1, with appropriate groups of data and data entities specified within the outermost data group, according to the structure of the particular source information.

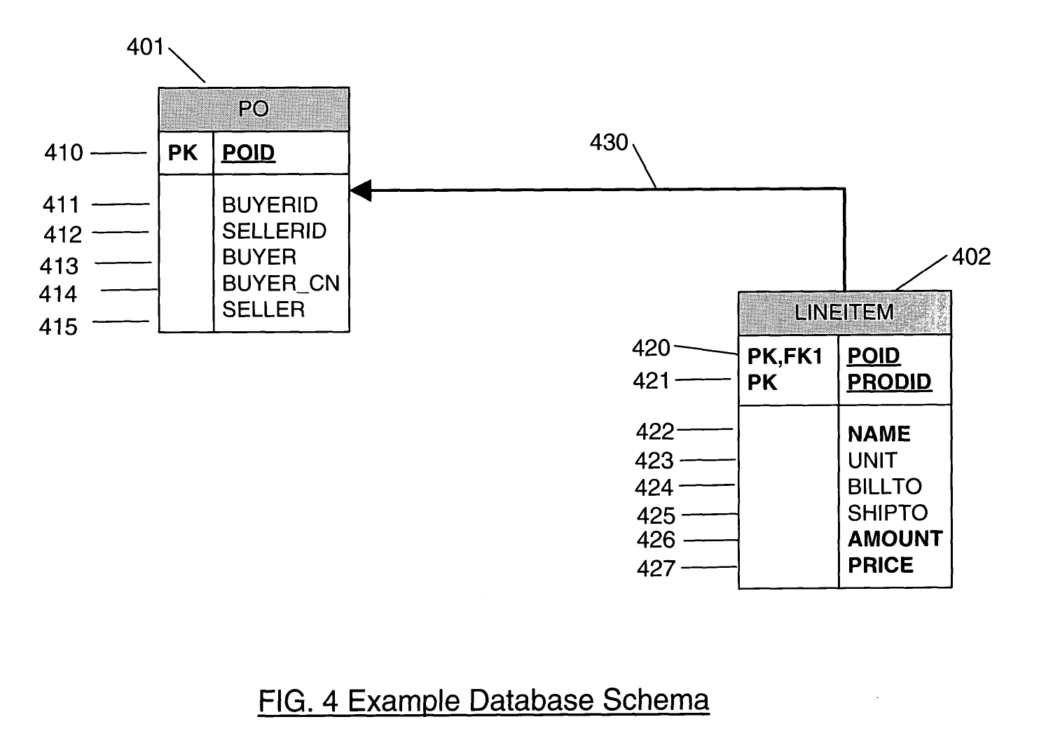

An example Relational Database schema in FIG. 4 shows two tables 401 and 402 in the database. Table 401 stores information about a purchase order (PO) and uses a primary key (POID) 410 as the primary identifier for each record. Table 402 stores information about a particular line item (LINEITEM) which was purchased. The relationship between records in each of these tables is described using the primary key POID 410. A complete purchase order record would require a query to table 401 to retrieve the buyer information (411, 413, 414) and seller information (412, 415), using a join 430 to table 402 to retrieve information about each item purchased. This join relationship inherently produces a tree structure of queries, where an initial query on table 401 will result in a key 410 which is in turn used in subsequent queries to retrieve the appropriate results from table 402. XRTL provides the necessary constructs to specify the mapping of the records/columns of the relational table model onto the elements/attributes of the XML object and imposing a hierarchical structure on the output. XRT supports insert, update and delete Structured Query Language (SQL) functions for mapping an XML object onto a relational database, for operations within a tree-structured transactional framework (SQL is a language used to retrieve data from databases). It also specifies the source or sink databases that are used during the transformation. XRT supports the specification of multiple heterogeneous data sources and sinks, where each source or sink can be a file, a database, or an Internet data stream for example. XRTL is used to create an XRT script. An XRT script specifies the sources/sinks of the transformations, the mapping between the XML constructs and the relational database constructs, as well as additional information such as transactional groupings or structural patterns. Examples of such a script can be found in TABLE 2.

The transformation is defined as a process of data shredding (insertion) or data retrieval at the structure level rather than at the instance level. In other words, the process is defined based on the structure of the XML document and the schema of the database, rather than on the XML elements and the database tables and columns proper.

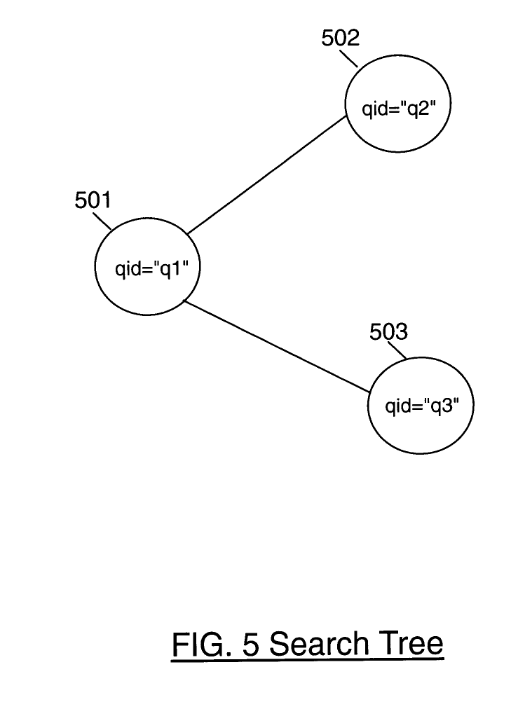

The template that defines a retrieval process is represented as a tree structure, called the “Search Tree”. The nodes of a Search Tree are specified by parameterized SQL commands. An example Search Tree is shown in FIG. 5. It corresponds to the retrieval template specified in TABLE 2. The Search node 501 of FIG. 5 corresponds to the query specified in lines A6-A12 in TABLE 2, the node 502 corresponds to the query specified in lines A13-A17 and node 503 corresponds to the query specified in lines A18-A22. Each node in the search tree may specify the database against which the corresponding query will be executed. In the script of TABLE 2, the only database specification is on line B4 in the xrt:locator element, hence all the queries specified in the Search Tree will execute against this database. The information contained in xrt:locator may be either in the form of an identifying name, which will then be mapped to an additional external configuration script, or in the form of database parameters (including database name, user, password) which may be listed as attributes of line B4. The general syntax also allows for specification of different databases for individual queries. In the example script in TABLE 2, the search tree consists of search nodes (lines B5-B7, B8-B11) which may or may not be related. The relationship of each node in the search tree is defined by the parameter scoping. For example, line B10 specifies that the search node “q2” (shown as TABLE 2 line B8, and FIG. 5 node 502) uses a parameter whose value is determined from results of the query as specified by the attribute xrt:scopeqid, in this case, “q1”, or the previous search node (TABLE 2 line B5, FIG. 5 node 501). This parameter scoping is what determines the final hierarchy of the Search Tree.

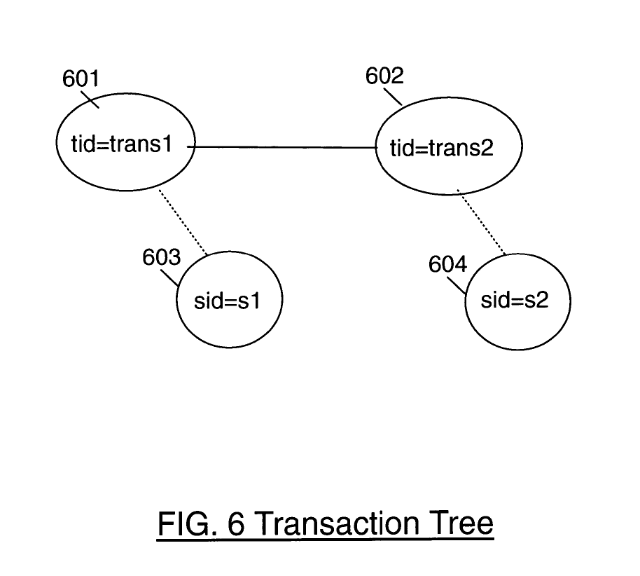

The template that defines the shredding, or data insertion, process is also represented as a tree structure, called the Transaction Tree. An example Transaction Tree specification is shown in FIG. 6 corresponding to the shredding script in TABLE 3. The structure of the Transaction Tree specifies the sequence of operations that insert the XML objects into the database. Each Transaction may have one or more sub-Transactions and one or more Store actions. For example Transaction Node 601 corresponding to lines C6-C16 in Table 3 has a sub-transaction 602 corresponding to lines C12-C15 and an insert action 603 corresponding to lines C7-C11.

TABLE 2
Example XRT Script for Retrieval

| | |
|---|---|
| B1 | <?xml version=“1.0”?> |
| B2 | <xrt:xrt xmlns:xrt=“http://www.xrt.org” |
| | xmlns:xsl=“http://www.w3.org/1999/XSL/Transform” > |
| B3 | <xrt:rdbms2xml> |
| B4 | <xrt:locator xrt:name=“d”/> |
| B5 | <xrt:sqlsearch xrt:qid=“q1”> |
| B6 | <xrt:query>select |
| | poid,buyer,seller,buyerid,sellerid from po</xrt:query> |
| B7 | </xrt:sqlsearch> |
| B8 | <xrt:sqlsearch xrt:qid=“q2”> |
| B9 | <xrt:query>select name,price from lineitem where |
| | poid=?</xrt:query> |
| B10 | <xrt:with-parameter xrt:position=“1” |
| | xrt:scopetype=“record” xrt:type=“integer” xrt:scopeqid=“q1” |
| | xrt:select=“$poid”/> |
| B11 | </xrt:sqlsearch> |
| B12 | </xrt:rdbms2xml> |
| B13 | <xrt:xml2xml> |
| B14 | <xsl:stylesheet version=“1.0” |
| | xmlns:xrt=“http://www.xrt.org” |
| | xmlns:xsl=“http://www.w3.org/1999/XSL/Transform”> |
| B15 | <xsl:template match=“store2xml”> |
| B16 | <xsl:element name=“polist”> |
| B17 | <xsl:apply-templates select=“q1” /> |
| B18 | </xsl:element> |
| B19 | </xsl:template> |
| B20 | <xsl:template match=“q1”> |
| B21 | <xsl:element name=“po”> |
| B22 | <xsl:element name=“id”><xsl:value-of |
| | select=“POID/@value”/></xsl:element> |
| B23 | <xsl:element name=“buyer”><xsl:value-of |
| | select=“BUYER/@value”/></xsl:element> |
| B24 | <xsl:element name=“seller”><xsl:value-of |
| | select=“SELLER/@value”/></xsl:element> |
| B25 | <xsl:apply-templates select=“q2”/> |
| B26 | </xsl:element> |
| B27 | </xsl:template> |
| B28 | <xsl:template match=“q2”> |
| B29 | <xsl:element name=“lineitem”> |
| B30 | <xsl:element name=“name”><xsl:value-of |
| | select=“NAME/@value”/></xsl:element> |
| B31 | <xsl:element name=“price”><xsl:value-of |
| | select=“PRICE/@value”/></xsl:element> |
| B32 | </xsl:element> |
| B33 | </xsl:template> |
| B34 | </xsl:stylesheet> |
| B35 | </xrt:xml2xml> |
| B36 | </xrt:xrt> |

The retrieval procedure corresponds to the generation of an XML object from data stored in a database. A set of optional external properties is used to initialize the retrieval process. This set is defined as a tuple set. Each of the tuples contains multiple columns. Each column has a name and data type. Each XRT script that defines a retrieval process has two parts:
1) A section that defines the relationship of the SQL queries (TABLE 2, lines B3-B23), which aids in the creation of the Search Tree; and
2) A section that defines the transformation from the results of the search tree into the output structure of XML (TABLE 2, lines B27-B39), which is specified by an XSL template.

The search tree consists of search nodes (lines B5-B7, B8-B11) which may or may not be related. The relationship of each node in the search tree is defined by the parameter scoping. For example, line B10 specifies that the search node B8 (named “q2”) uses a parameter whose value is determined from results of the query as specified by the attribute xrt:scopeqid, in this case, “q1”, or the previous search node (line B5). Each query node specified

The transformation is then executed in two major steps:
1) Information from the database is retrieved using the SQL queries in the Search Tree, thereby creating an intermediate XML that abides to a fixed format specified by an XML schema; and
2) The intermediate result is transformed into the required final output format using the XSL template.

### XML to RDBMS Transformation Shredding Procedure

TABLE 3
Example XRT Script for Shredding

| | |
|---|---|
| C1 | <?xml version=“1.0”?> |
| C2 | <xrt:xrt xmlns:xrt=“http://www.xrt.org/xrt” |
| | xmlns:xsl=“http://www.w3.org/1999/XSL/Transform”> |
| C3 | <xrt:xml2rdbms> |
| C4 | <xrt:locator xrt:name=“db1” /> |
| C5 | <xrt:transaction xrt:tid=“trans1”> |
| C6 | <xrt:sqlinsert xrt:sid=“s1” |
| | xrt:tablename=“xrt.user” xrt:template-name=“user-template”> |
| C7 | <xrt:column xrt:name=“userid” |
| | xrt:type=“string”/> |
| C8 | <xrt:column xrt:name=“workspacename” |
| | xrt:type=“string”/> |
| C9 | <xrt:column xrt:name=“country” |
| | xrt:type=“string”/> |
| C10 | </xrt:sqlinsert> |
| C11 | <xrt:transaction xrt:tid=“trans2”> |
| C12 | <xrt:sqlinsert xrt:sid=“s2” |
| | xrt:tablename=“xrt.user2pubpath” |
| C13 | xrt:template-name=“pub-template”> |
| C14 | <xrt:column xrt:name=“pubpath” |
| | xrt:type=“string”/> |
| C15 | </xrt:sqlinsert> |
| C16 | </xrt:transaction> |
| C17 | </xrt:transaction> |
| C18 | </xrt:xml2rdbms> |
| C19 | <xrt:xml2xml> |
| C20 | <xsl:stylesheet version=“1.0” |
| | xmlns:xsl=“http://www.w3.org/1999/XSL/Transform” |
| | xmlns:xrt=“http://www.xrt.org/xrt”> |
| C21 | <xsl:output method=“xml” indent=“yes”/> |
| C22 | <xsl:template name=“user-template”> |
| C23 | <xsl:element name=“xrt:record”> |
| C24 | <xsl:element name=“xrt:column”> |
| C25 | <xsl:attribute |
| | name=“xrt:name”>userid</xsl:attribute> |
| C26 | <xsl:attribute name=“xrt:value”> |
| C27 | <xsl:value-of |
| | select=“/user/name”/> |
| C28 | </xsl:attribute> |
| C29 | </xsl:element> |
| C30 | <xsl:element name=“xrt:column”> |
| C31 | <xsl:attribute |
| | name=“xrt:name”>workspacename</xsl:attribute> |
| C32 | <xsl:attribute name=“xrt:value”> |
| C33 | <xsl:value-of |
| | select=“/user/workspacename”/> |
| C34 | </xsl:attribute> |
| C35 | </xsl:element> |
| C36 | <xsl:element name=“xrt:column”> |
| C37 | <xsl:attribute |
| | name=“xrt:name”>country</xsl:attribute> |
| C38 | <xsl:attribute name=“xrt:value”> |
| C39 | <xsl:value-of |
| | select=“/user/country”/> |
| C40 | </xsl:attribute> |
| C41 | </xsl:element> |
| C42 | </xsl:element> |
| C43 | </xsl:template> |
| C44 | </xsl:stylesheet> |
| C45 | </xrt:xml2xml> |
| C46 | </xrt:xrt> |

A shredding procedure consists of processing a specific XML document and inserting data from it into one or more RDBMS systems. Similar to the retrieval process, the shredding is defined at the structure level rather than the instance level. Each XRT script that defines the shredding has two parts:
1) The XSL part that defines the transformation from the original XML into an intermediate XML format (Table 3, lines C19-C45); and
2) the second part that defines the shredding actions into RDBMS systems and defines the sequence of executing the actions based on the transaction tree (TABLE 3, lines C3-C18).

An XML file and a set of optional external properties initialize an instance of the shredding procedure defined by the XRT script. The transformation is also completed in two major steps:
1) the XML object is converted into an intermediate XML object specified by an XML schema; and
2) the intermediate XML object is parsed, thereby generating the RDBMS SQL commands and the information is automatically stored into RDBMS using JDBC.

The Transaction Tree is a hierarchy of database transactions. Each Transaction (TABLE 3, line C5) can have multiple sub-Transactions (line C11) as well as database store operations (line C6). Each Store operation can consist of multiple database actions, all targeted to the same database, whereas a Transaction can consist of multiple Store operations targeted to different databases. The supported database actions are Insert, Update, Delete and InsertUpdate. The Insert, Update, and Delete actions correspond to the equivalent database operations, while the InsertUpdate action is defined as either an update or an insert operation depending on whether a corresponding record exists in the database or not. In other words, for an InsertUpdate procedure, if a record matching the one to be inserted exists, then an Update on the record occurs, otherwise a new record is inserted. The order of Store operations in a Transaction is important, and the success of a Transaction is determined by the successful completion of all of the child Store actions of this Transaction. The sub-Transactions of a Transaction are executed only after all the Store actions of the Transaction are completed. The sub-Transactions are independent of each other. TABLE 3 shows an example of a Transaction Tree hierarchy. The root Transaction C5-C17 shows a child Store action that defines an Insert C6-C10, as well as a sub-Transaction C11-C16 that contains its own set of Store actions. The root Transaction C5-C17 is a success if the Store action C6-C10 completes successfully, upon which the sub-Transaction C11-C16 can then be completed.

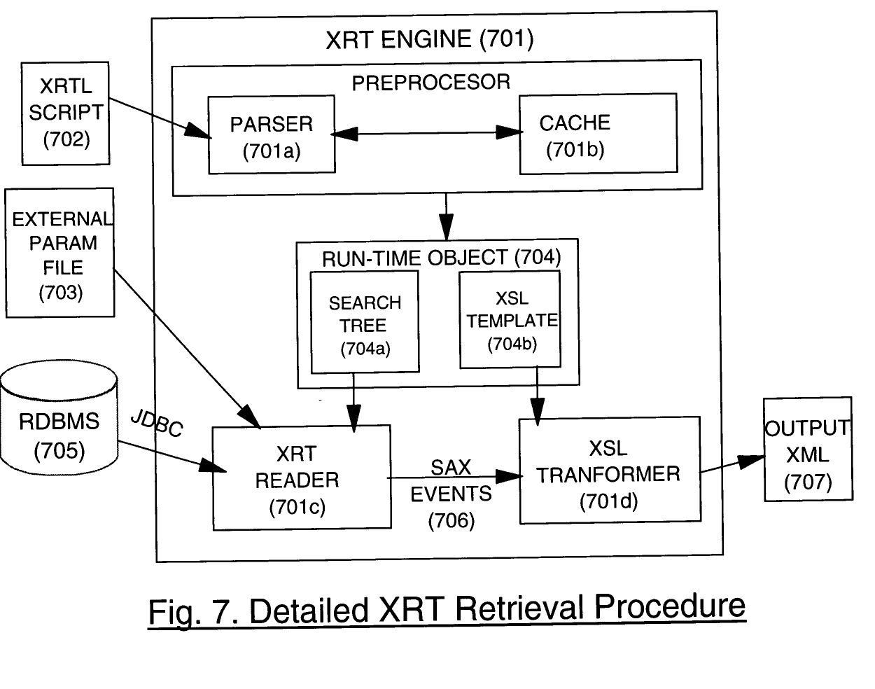

The run-time engine is designed to accept an XRT script as a template for performing transformations. For retrieval procedures, the run-time engine expects a RDBMS to XML transformation XRT script and an optional external parameters file in an XML format. An additional script which stores database configuration information may also be used. FIG. 7 shows the process of the retrieval procedure and the components that are required for execution. For shredding procedures, a run-time engine expects a shredding XRTL script and an input XML to act upon.

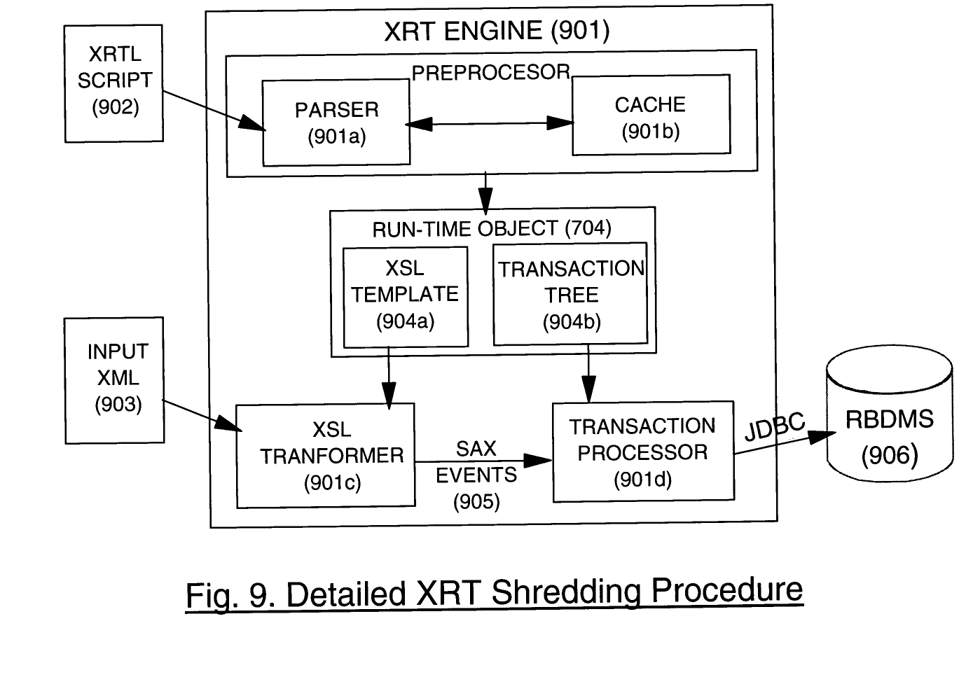

FIG. 9 shows the process of the shredding procedure and the components that are required for execution. Since a given script is likely to be used for multiple transformations within the lifetime of an application, the run-time engine contains a cache which stores the parsed XRTL script as a run-time object. The run-time engine is preferably implemented in Java, and distributed as a jar file to be used in conjunction with an XML parser, an XSL processor, and the appropriate JDBC drivers for each database being used.

The implementation of the run-time engine is independent of any application oriented considerations. All application specific information is externalized in the XRT script or property files. In other words, the main run-time does not contain specific information regarding what data store to connect to or which elements should be obtained. The XRT scripts contain the necessary information for data access and transformation, and the property files contain information for specific transformations or database parameters. Consequently, a single XRT run-time engine may be reused for any number of applications.

### Detailed Process of the Retrieval Procedure

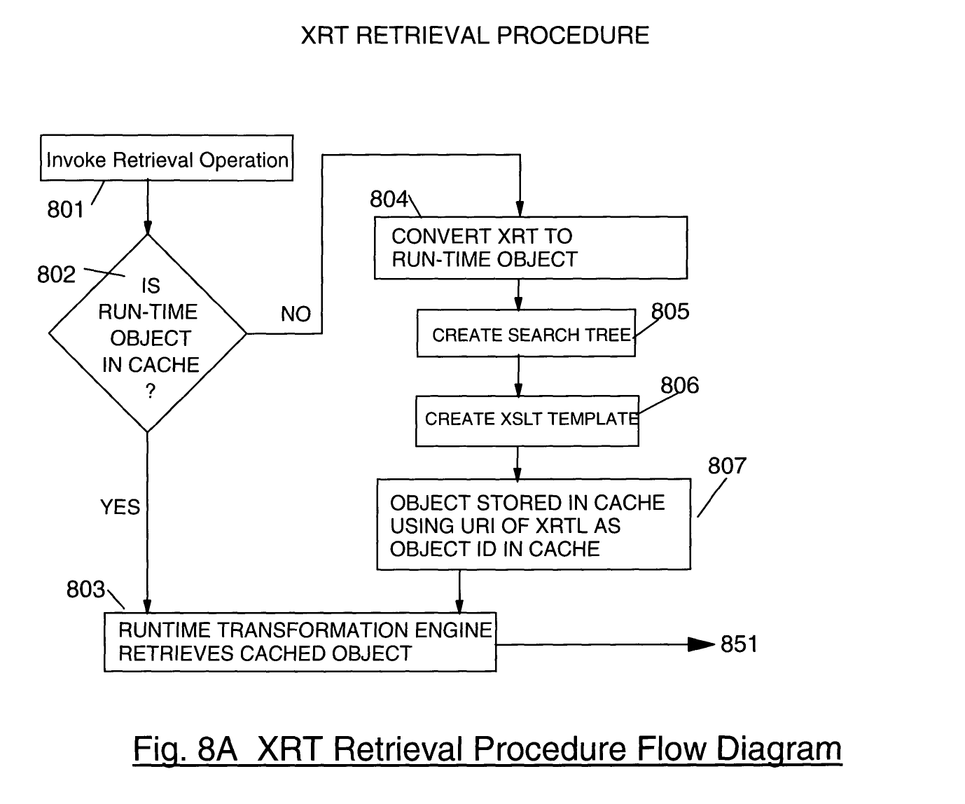

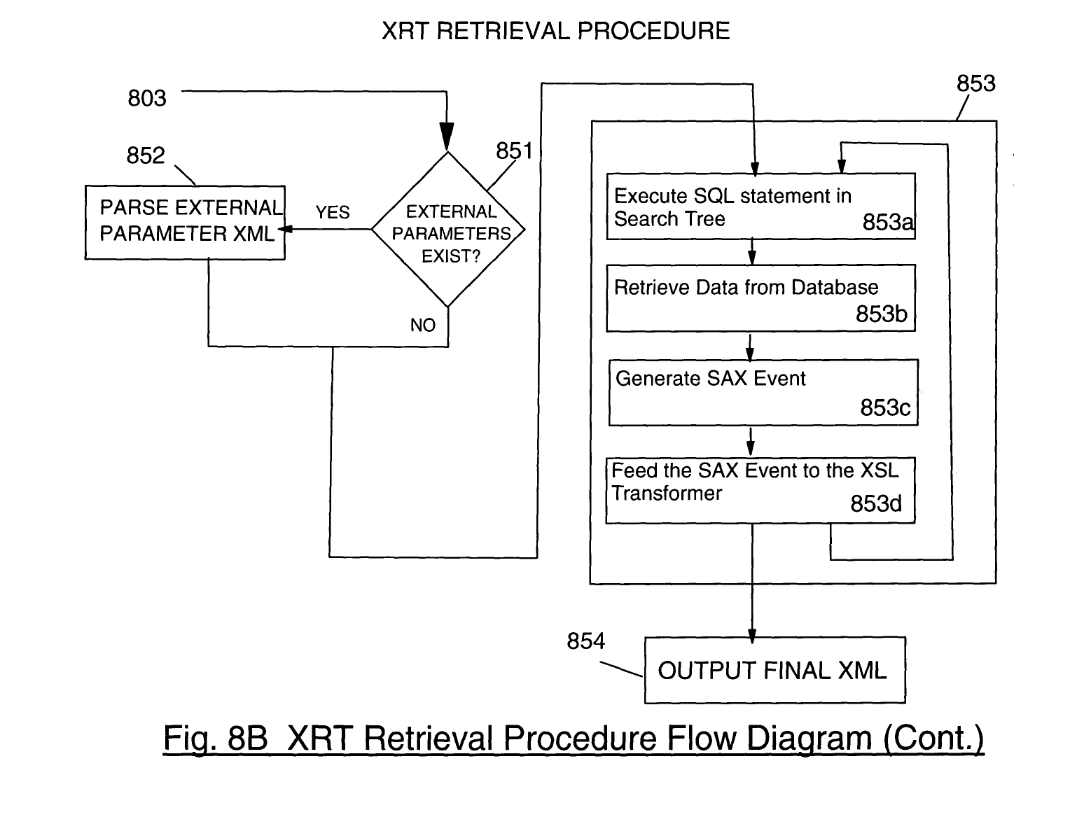

A block diagram showing the steps involved in the retrieval process is shown in FIG. 7 and the corresponding flow is shown in FIG. 8.

The components involved in the retrieval procedure are shown in FIG. 7.

The XRT run-time transformation engine (701) consists of 4 main components:

The XRT parser (701a) that reads input XRT scripts (702) and creates the corresponding Run-Time Object (704);

The Cache (701b) where the Run-Time Objects are stored for multiple use. The usage pattern that has been identified is that the same XRT script is used multiple times with different External Parameters (703). Caching the Run Time Object (704) provides a significant speed-up, since it avoids parsing the same XRT script (702) more than once;

The actual transformation procedure starts in the XRT Reader (701c), that executes the retrieve instructions as specified in the Run-Time Object and uses as input an optional External Parameter File (703) and the database or databases (705) specified in the Run-Time Object; It creates a sequence of SAX events that are passed to the XSL Transformer; and

The XSL transformer (701d) absorbs the SAX events generated by the XRT Reader and transforms the logical XML specified by this sequence of events based on the XSL instructions in the Run-Time object (704) to create the Output XML (707)

The Run-Time Object (704) itself contains 2 components:

The Search Tree (704a), that represent the SQL queries specified in the original XRT script (702) and their relationships; and

The XSL template object (704b), that is the run-time representation of the XSL instructions in the XSL portion of the original XRT script (702).

The detailed steps of the retrieval procedure are as follows (refer to FIG. 8A and 8B, in conjunction with FIG. 7):

In Step (801), the XRT run-time transformation engine (701) is invoked to process a certain retrieval operation with a a particular XRT Script (702) specified with an URA and an optional External Parameter File (703);

In Step (802), the engine checks whether the specified XRT Script has been already processed and the corresponding Run-Time Object exists in the Cache;

If the Run-Time Object does not exists in cache, the XRT Script is loaded through the specified URA and parsed in step 804 by the parser (701a) and the corresponding Search Tree and XSL Template created (Steps 805 and 806);

The created objects are stored in the cache with the XRT Script URA as the entry key (Step 807);

Whether the run-time object was in the cache originally, or was created and cached during the current invocation, it is retrieved from the cache in step 803;

In Step 851, the system checks whether an external parameters file was specified for this invocation, and if so parses it (Step 852);

In Step 853, the XRT reader (701c) of the engine runs the Search Tree (704a) and executes the SQL commands from the Tree (Step 853a), using the external parameters (703) as parameters to the SQL commands, if appropriate;

As a result, information is retrieved from the database (Step 853b) via JDBC and the results are passed to the XSL transformer as SAX events (Step 853c);

In Step 653d, the SAX events are fed to the XSL Transformer (501d) and the XSL template (704b) of the stored object is applied, to build the final XML; and

Steps 853a, 853b, 853c and 853d are executed as long as the search tree has more queries.

### Detailed Process of the Shredding Procedure

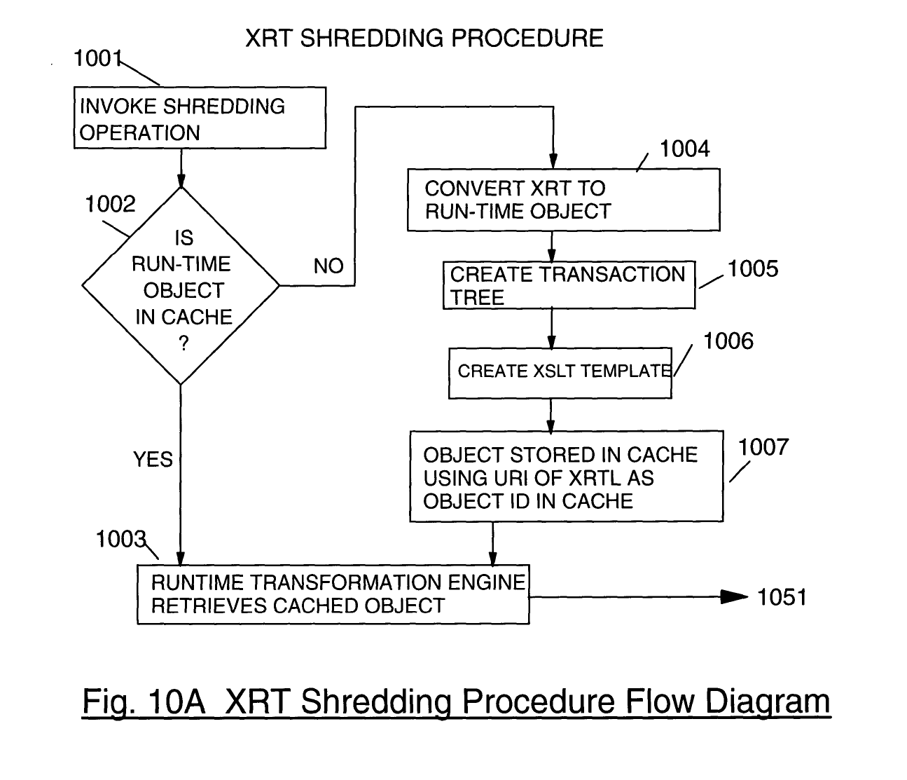

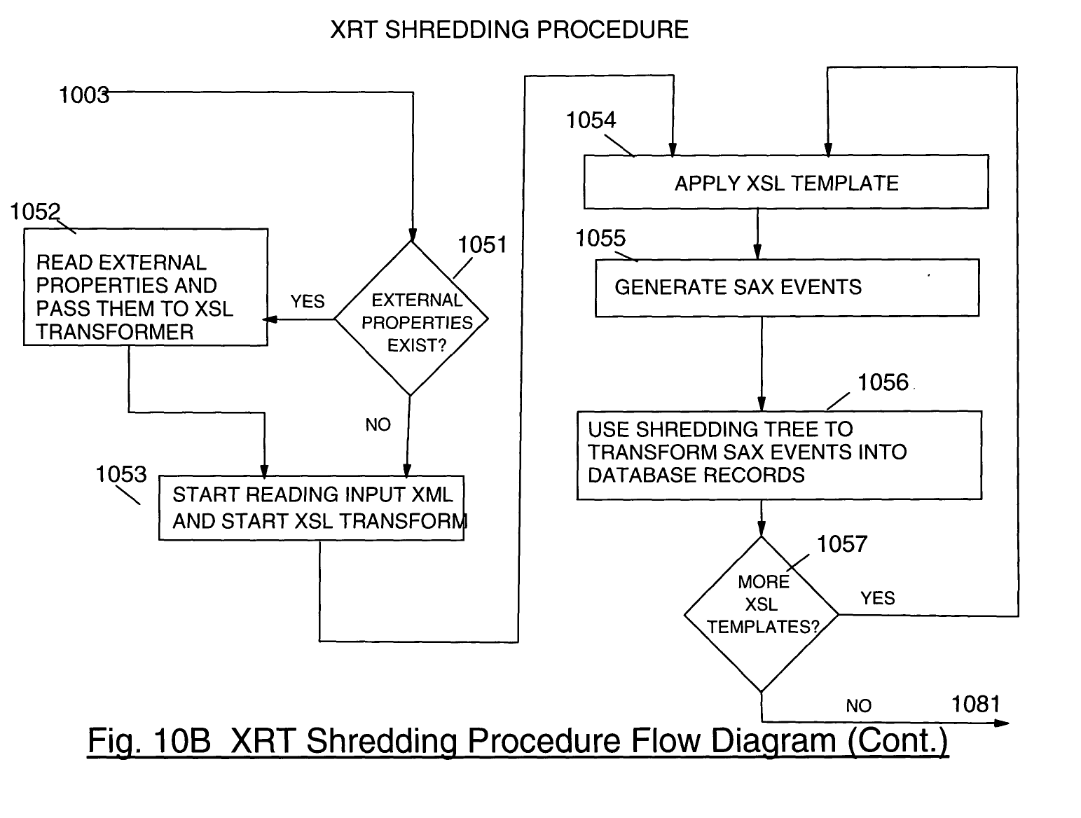

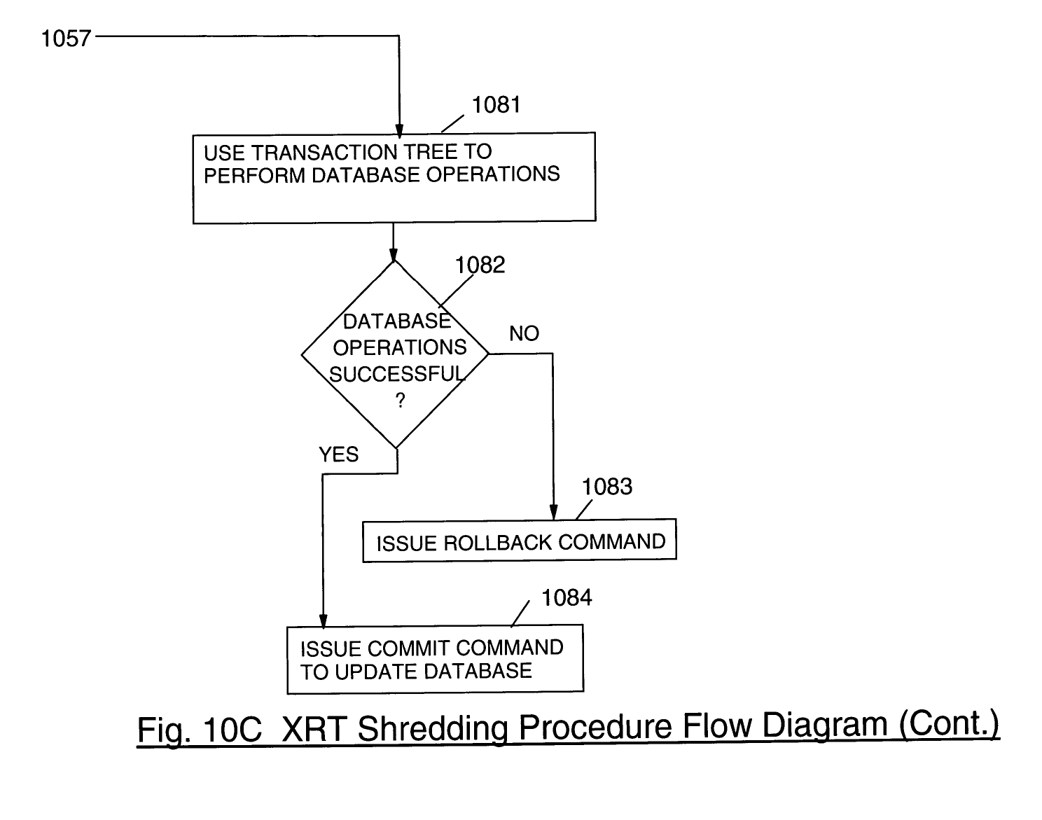

A block diagram showing the steps involved in the shredding process is shown in FIG. 9 and the corresponding flow is shown in FIG. 10.

The components involved in the shredding procedure are shown in FIG. 9.

The XRT run-time transformation engine (901) consists of 4 main components:

The XRT parser (901a) that reads input XRT scripts (902) and creates the corresponding Run-Time Object (904);

The Cache (901b) where the Run-Time Objects are stored for multiple use. The usage pattern that has been identified is that the same XRT script is used multiple times with different Input XML documents (903); Caching the Run Time Object (904) provides a significant speed-up, since it avoids parsing the same XRT script (902) more than once;

The actual transformation procedure starts in the XSL Transformer (901c), that executes the XSL instructions as specified in the Run-Time Object and uses as input the Input XML document (903); It creates a sequence of SAX events (905) that are passed to the Transaction Processor (901d); and

The Transaction Processor (901d) absorbs the SAX events generated by the XSL Transformer and transforms them into database records that are eventually inserted into the RDBMS (906).

The Run-Time Object (904) itself consists of 2 components:

The XSL template object (904a), that is the run-time representation of the XSL instructions in the XSL portion of the original XRT script (902); and

The Transaction Tree (904b) that specifies how database records are to be composed from the SAX Events (905) and the order in which those records are to be inserted into the RDBMS.

The detailed steps of the shredding procedure are as follows (refer to FIG. 10A, 10B and 10C, in conjunction with FIG. 9):

In Step (1001), the XRT run-time transformation engine (901) is invoked to process a certain shredding operation with a particular XRT Script (902) specified with an URA and an Input XML document (903);

In Step (1002), the engine checks whether the specified XRT Script has been already processed and the corresponding Run-Time Object exists in the Cache;

If the Run-Time Object does not exists in cache, the XRT Script is loaded through the specified URA and parsed in step 1004 by the parser (901a) and the corresponding Transaction Tree and XSL Template are created (Steps 1005 and 1006);

The created objects are stored in the cache with the XRT Script URA as the entry key (Step 1007);

Whether the run-time object was in the cache originally, or was created and cached during the current invocation, it is retrieved from the cache in (step 1003);

In Step 851, the system checks whether external parameters were specified for this invocation, and if so it passes them to the XSL Transformer (Step 1052);

In Step 1053, the XSL Transformer (901c) of the engine starts reading in the Input XML (902) and applying the XSL templates specified in the XSL Templates object (904a);

As each XSL template is applied to the Input XML (Step 1054), SAX Events are generated (Step 1055);

The SAX Events are passed to the shredding Tree that transforms the SAX Events into database records (Step 1056);

As long as there are XSL templates to apply, Steps 1054, 1055 and 1056 are repeated;

When all XSL templates are applied, the Transaction Tree starts executing the database operations in the order and sequence specified within the tree (Step 1081);

If a particular database operation fails, all database operations specified within the scope of a transaction are rolled back (Step 1083);

If all the database operations specified within the scope of a transaction are completed successfully, all these operations are committed (Step 1084); and

The procedure terminates when all the transactions specified in the Transaction Tree are executed.

While the preferred embodiment of the invention has been illustrated and described herein, it is to be understood that the invention is not limited to the precise construction herein disclosed, and the right is reserved to all changes and modifications coming within the scope of the invention as defined in the appended claims.

1. A computer program product for creating an XML representation of data stored in a relational database system, the computer program product comprising a computer readable medium having computer readable program code therein, the computer program product comprising:
computer readable program code for specifying a set of conditions that data to be retrieved from the relational database system must satisfy;
computer readable program code for specifying an output format that the XML representation must satisfy;
computer readable program code for creating from the set of conditions and the format, a mapping description using a markup language, the markup language comprising SQL function and XSL function;
computer readable program code for retrieving data from the relational database using the mapping description in association with a standard database access method; and
computer readable program code for formatting an XML object representing the retrieved data using the mapping description.

2. The computer program product according to claim 1 wherein the mapping description comprises a first section and a second section wherein the first section defines the data to be retrieved from the database using the specified set of conditions that the data must satisfy; and the second section defines the output format.

3. The computer program product according to claim 2 wherein the first section comprises a list of individual search conditions.

4. The computer program product according to claim 3 wherein a search condition comprises the syntax of an SQL prepared statement specifying one or more tables upon which the statement will act; one or more columns of the table that will be retrieved; and a list of parameters for determining a location where a value of a parameter is to be obtained, the value of the parameter to be used in a condition clause of the SQL prepared statement.

5. The computer program product according to claim 3 further comprising computer readable program code for creating a first run-time object representing elements of the mapping description wherein the run-time object represents a search condition as a JDBC prepared statement and defines Java variables for the values of the parameters.

6. The computer program product according to claim 5 wherein the first run-time object produces an internal representation of the data retrieved from the database the computer program product further comprising:
computer readable program code for providing the value of a variable needed for a first SQL prepared statement;
computer readable program code for executing the first SQL prepared statement; and
computer readable program code for storing a result of the executing step as an internal representation.

7. The computer program product according to claim 6 further comprising:
computer readable program code for invoking an XSL transformation engine with the second run-time object; and
computer readable program code for operating on the internal representation using the second run-time object.

8. The computer program product according to claim 6 further comprising:
computer readable program code for generating software events;
computer readable program code for generating data associated with the software events; and
computer readable program code for sequencing the software events and the associated data based on the internal representation of the retrieved data.

9. The computer program product according to claim 8 further comprising computer readable program code for providing the software events and associated data to the XSL transformation, the providing being performed for any one of: a single event; a sub-group of events; or a group comprising all of the generated events.

10. The computer program product according to claim 1 wherein the output format comprises XSL syntax for determining a transformation that is to be applied to an internal representation of the data retrieved from database according to the specification.

11. The computer program product according to claim 10 further comprising computer readable program code for creating a second run-time object using a Xalan Templates object for representing the XSL transformation.

12. The computer program product according to claim 1 further comprising:
computer readable program code for creating a run-time object;
computer readable program code for saving the run-time object in a run-time object cache;
computer readable program code for using the cached run-time object.

13. A computer program product for updating information stored in a relational database based on data extracted from an XML object, the computer program product comprising the steps of:
computer readable program code for specifying a set of conditions that data retrieved from the XML object system must satisfy;
computer readable program code for specifying a set of actions that need to be executed on the tables of one or more database;
computer readable program code for creating from the set of conditions and the set of actions, a mapping description using a markup language, the markup language having SQL function and XSL function;
computer readable program code for retrieving XML object data from the XML object using the mapping description in association with a standard XML processing method; and
computer readable program code for performing an action on the database using the mapping description in association with a standard database access method.

14. The computer program product according to claim 13 wherein the mapping description comprises a first section and a second section, the first section defining the XML object data to be retrieved from the XML object; the second section defining database operations to be performed.

15. The computer program product according to claim 14 further comprising:
computer readable program code for specifying in XSL syntax, a location of the XML object data to be retrieved from the XML object, wherein the XSL syntax determines a transformation;
computer readable program code for retrieving XML object data;
computer readable program code for creating an internal representation of required data from the XML object data based on the transformation.

16. The computer program product according to claim 15 further comprising:
computer readable program code for creating a first run-time object which first run-time object uses a Xalan Templates object, wherein the first run-time object represents the XSL transformation.

17. The computer program product according to claim 13 wherein the mapping description specifies a sequence of database operations and their respective inputs.

18. The computer program product according to claim 17 further comprising computer readable program code for specifying input to a database operation using an XSL template.

19. The computer program product according to claim 17 wherein a database operation comprises any one of insert; update; update/insert or delete.

20. The computer program product according to claim 17 wherein an operation comprises an SQL prepared statement.

21. The computer program product according to claim 17 further comprising computer readable program code for sequencing database operations as segmented transactional groups.

22. The computer program product according to claim 17 further comprising:
computer readable program code for creating a second run-time object that represents elements of the mapping description;
computer readable program code for representing, by the second run-time object, a database operation as a JDBC prepared statement; and
computer readable program code for defining JAVA variables by way of the second run-time object, the JAVA variables holding values of parameters.

23. The computer program product according to claim 22 further comprising:
computer readable program code for associating with an SQL statement, a value of a variable from the internal representation of retrieved data;
computer readable program code for executing the SQL statement.

24. The computer program product according to claim 23 wherein the database operations are performed by respecting predefined transactional boundaries such that an operation in a group is only completed if all the operations of the group can be executed successfully.

25. The computer program product according to claim 13 further comprising:
computer readable program code for creating a run-time object;
computer readable program code for invoking by the run-time object, an XSL transformation engine;
computer readable program code for creating an internal representation of retrieved data from input from the XML object using the XSL transformation engine.

26. The computer program product according to claim 13 further comprising:
computer readable program code for creating a run-time object;
computer readable program code for saving the run-time object in a run-time object cache
computer readable program code for using the cached run-time object in a procedure.

27. A method for creating an XML representation of data stored in a relational database system, the method comprising the steps of:
specifying a set of conditions that data to be retrieved from the relational database system must satisfy;
specifying an output format that the XML representation must satisfy;
creating from the set of conditions and the format, a mapping description using a markup language, the markup language comprising SQL function and XSL function;
retrieving data from the relational database using the mapping description in association with a standard database access method; and
formatting an XML object representing the retrieved data using the mapping description.

28. A method for updating information stored in a relational database based on data extracted from an XML object, the method comprising the steps of:
specifying a set of conditions that data retrieved from the XML object system must satisfy;
specifying a set of actions that need to be executed on the tables of one or more database;
creating from the set of conditions and the set of actions, a mapping description using a markup language, the markup language having SQL function and XSL function;
retrieving XML object data from the XML object using the mapping description in association with a standard XML processing method; and
performing an action on the database using the mapping description in association with a standard database access method.

29. A system for creating an XML representation of data stored in a relational database system, the system comprising:
a user specified set of conditions that data to be retrieved from the relational database system must satisfy and user specified output format that the XML representation must satisfy;
a mapper creating from the set of conditions and the format, a mapping description using a markup language, the markup language comprising SQL function and XSL function;
a retriever retrieving data from the relational database using the mapping description in association with a standard database access method; and
a formatter formatting an XML object representing the retrieved data using the mapping description.

30. A system for updating information stored in a relational database based on data extracted from an XML object, the system comprising:
a user specified set of conditions that data retrieved from the XML object system must satisfy, and a set of actions that need to be executed on the tables of one or more database;
a mapper creating from the set of conditions and the set of actions, a mapping description using a markup language, the markup language having SQL function and XSL function;
a retriever retrieving XML object data from the XML object using the mapping description in association with a standard XML processing method; and
a performer performing an action on the database using the mapping description in association with a standard database access method.
